(19) United States
(12) Patent Application Publication
(10) Pub. No.: US 2024/0119450 A1
(43) Pub. Date: Apr. 11, 2024

(54) Method For Implementing Derivative NFT, Apparatus Therefor And Computer-Readable Storage Medium

(71) Applicant: Supersymmetry Pte. Ltd, Singapore (SG)

(72) Inventors: Yin Wang, Shanghai (CN); Dinghao Zeng, Shanghai (CN); Zhi Yang, Shanghai (CN); Caihong Wu, Shanghai (CN)

(21) Appl. No.: 18/048,472

(22) Filed: Oct. 21, 2022

Related U.S. Application Data
(63) Continuation of application No. PCT/CN2022/124660, filed on Oct. 11, 2022.

(51) Int. Cl. G06Q 20/38

(52) U.S. Cl. CPC G06Q 20/389

(57) ABSTRACT

A method and an apparatus for implementing a derivative NFT and a computer-readable storage medium are disclosed, and the method includes providing a smart contract and changing an owner of each of one or more source NFTs to the provided smart contract, minting a derivative NFT in the provided smart contract, with the derivative NFT representing derivative works derived from works represented by the one or more source NFTs, and recording a derivation relationship between the derivative NFT and the one or more source NFTs. With the use of the method, there is provided a way of representing the derivative works on the blockchain in such a way that the derivation of the derivative works from the source works is clearly indicated, thereby enabling the on-chain transaction of the derivative works.

### CROSS-REFERENCE TO RELATED APPLICATIONS

This application is a continuation of PCT Application No. PCT/CN2022/124660 filed on Oct. 11, 2022. The entire disclosure of the above application is incorporated herein by reference.

### TECHNICAL FIELD

The present disclosure relates to the field of blockchain technology, particularly to Non-Fungible Token (NFT) technology, and more particularly to a method and an apparatus for implementing a derivative NFT and a computer-readable storage medium.

### BACKGROUND

This section is intended to provide a background or context for embodiments of the invention as defined in the claims, and description therein shall not be interpreted as prior art merely due to its presence in this section.

Thanks to a tamper resistance characteristic of blockchain technology, an effective and secure co-sharing value system has been established based on the blockchain technology. For example, blockchain-based NFTs, which have uniqueness, have been widely utilized in various artwork scenarios.

More and more creators create and put their artworks onto the blockchain, and NFTs are utilized as the unique trusted digital benefits credentials on the blockchain for these artworks. In creation scenarios such as a secondary creation scenario and a cooperative creation scenario, some creators modify works represented by the existing NFTs (which is also referred to as source works hereinafter) on the blockchain to obtain derivative works, but so far no mechanism representing the derivation of the derivative works from the source works is available on the blockchain.

Therefore, there is a problem in representing the derivative works on the blockchain in such a way that the derivation of the derivative works from the source works is clearly indicated.

### SUMMARY

In view of the above problem in the prior art, embodiments of the present invention at least provide a method and an apparatus for implementing a derivative NFT and a computer-readable storage medium, to address the above problem.

In a first aspect, provided is a method for implementing a derivative NFT, which includes: providing a smart contract and changing an owner of each of one or more source NFTs to the provided smart contract; minting a derivative NFT in the provided smart contract, with the derivative NFT representing derivative works derived from works represented by the one or more source NFTs; and recording a derivation relationship between the derivative NFT and the one or more source NFTs.

In an embodiment, the method may further include generating modification description, which describes a modification made to the works represented by the one or more source NFTs to obtain the derivative works and which is included in metadata of the derivative NFT.

In an embodiment, the derivation relationship between the derivative NFT and the one or more source NFTs may be recorded in the smart contract on blockchain or recorded off blockchain.

In an embodiment, the derivation relationship may include mapping between an address of an original smart contract in which each of the one or more source NFTs is minted as well as a Token ID of each of the one or more source NFTs and a Token ID of the derivative NFT.

In an embodiment, the method may further include recording an original owner of each of the one or more source NFTs in the provided smart contract, to allow verifying the source of the derivative NFT and/or restoring the one or more source NFTs.

In an embodiment, the method may further include restoring each of the one or more source NFTs by: determining the original smart contract in which the source NFT is minted, based on the derivation relationship, by the provided smart contract; changing the owner of the source NFT from the provided smart contract to the recorded original owner of the source NFT, in the determined original smart contract; and burning the derivative NFT after the owner of each of the one or more NFTs has been changed to the original owner.

The derivative NFT may be traded as usual. For example, in an embodiment, the owner of the derivative NFT may be changed from the provided smart contract to a target account on blockchain as desired. In this case, for restoring each of the one or more source NFTs, the owner of the derivative NFT owned by the target account needs to be changed back to the provided smart contract or the derivative NFT needs to be authorized by the target account to the provided smart contract, so as to proceed with restoring the source NFTs.

In an embodiment, the derivative NFT may be utilized as a source NFT to recursively implement a next-generation derivative NFT.

In a second aspect, provided is an apparatus for implementing derivative NFT which includes at least one processor and a storage device in communication with the at least one processor, where the storage device is stored with instructions which, when executed by the at least one processor, cause the at least one processor to perform the above method of implementing a derivative NFT.

In a third aspect, provided is a computer-readable storage medium stored with a program which, when executed by a processor, causes the processor to perform the above method for implementing a derivative NFT.

The solutions in the above embodiments are advantageous in that: given the derivative works derived from source works represented by one or more source NFTs, a derivative NFT representing the derivative works which is more applicable to a secondary creation scenario or a cooperative creation scenario may be minted in such a way that the derivation of the derivative works from the source works is clearly indicated, and the source NFTs are prevented from being traded once the derivative NFT is minted, thereby enabling the on-chain transaction of the derivative works and lowering the costs for transfer transactions of NFTs on the blockchain.

Further, by storing the derivation relationship between the derivative NFT and the one or more source NFTs and the original owner of each of the one or more source NFTs, traceback of the source NFTs is enabled to allow for verification of the source of the derivative NFT, and further the source NFTs can be restored as desired, thus providing significant flexibility.

Other advantages of the present disclosure will be described in detail with reference to the accompanying drawings.

It should be noted that the aforesaid description only shows a summary of the technical solutions of the present disclosure to facilitate better understanding of technical means of the present disclosure for implementing the present disclosure in accordance with the content described in the specification. Specific embodiments of the present disclosure will be given below to make the above and other objects, features, and advantages of the present disclosure more apparent.

### BRIEF DESCRIPTION OF THE DRAWINGS

By reading following details of the exemplary embodiments below, those of ordinary skills in the art may understand the advantages and benefits described herein and other advantages and benefits. The accompanying drawings are for the purpose of illustrating exemplary embodiments only and are not intended to limit the present disclosure. Further, a same reference sign is adopted to indicate a same component throughout the accompanying drawings. In the accompanying drawings:

FIG. 1 is a schematic flowchart of a method for implementing a derivative NFT according to an embodiment of the present invention,

FIG. 2 is a schematic flowchart of a method for restoring one or more source NFTs from a derivative NFT according to an embodiment of the present invention,

FIG. 3 shows an example of minting a derivative NFT using the method according to the embodiment of the present invention,

FIG. 4 shows an example of minting a derivative NFT using the method according to the embodiment of the present invention,

FIG. 5 shows an example of minting a derivative NFT using the method according to the embodiment of the present invention, and

FIG. 6 is a schematic diagram showing the structure of an apparatus for implementing a derivative NFT according to an embodiment of the present invention.

### DETAILED DESCRIPTION

Exemplary embodiments of the present disclosure will be described below in more detail with reference to the accompanying drawings. Although the accompanying drawings illustrate exemplary embodiments of the present disclosure, it should be understood that the present disclosure can be implemented in various forms and should not be construed as being limited to embodiments described herein. Rather, these embodiments are provided so that the present disclosure will be understood thoroughly, and will fully convey the scope of the present disclosure to those skilled in the art.

In the present disclosure, it should be understood that terms such as “include”, “including”, “comprise” and “comprising” are intended to indicate the presence of the characteristics, figures, steps, actions, components and parts disclosed by the specification or any combination thereof, without excluding the presence of one or more other characteristics, figures, steps, actions, components, parts or any combination thereof.

Unless otherwise specified, the symbol “/” refers to “or”, for example, a term “A/B” refers to “A or B”, and a term “A and/or B” refers to the presence of merely A, the presence of merely B, and the presence of both A and B.

Terms “first”, “second” and so on are used to distinguish one feature from other same features, rather than implying or indicating that one of these features is more important than the other ones or implying the number of the features.

Furthermore, it should be noted that, in the case of no conflict, the embodiments of the present invention and features of the embodiments may be combined with each other in any manner. The present disclosure will be described in detail below with reference to the accompanying drawings and embodiments.

For better understanding of the various embodiments of the invention, some terms are briefly described below.

Smart contract: which is a commitment defined in a digital form. The smart contract is deployed in the form of executable codes (which may be accompanied by possible data) on the blockchain and cannot be modified. If conditions defined in the smart contract are accomplished, the smart contract is executed automatically.

NFT: which is a trusted digital benefits credential with uniqueness in a blockchain-based network. The NFT is embodied as a data object adapted to record and process multidimensional complicated properties on the blockchain.

To at least partially address one or more of the above and other problems, an embodiment of the present invention provides a method for implementing a derivative NFT.

As well known, a created artwork may be represented by an NFT minted on the blockchain and then traded credibly on chain. Further, some creators may conduct a secondary creation based on on-chain works to obtain secondarily created works or derivative works. For example, music may be composed based on on-chain lyrics, a colorful painting may be created based on an on-chain line drawing, and so on. The secondarily created works typically comes up along with the original work on which the secondarily created works is based, thus there is a technical problem of on-chain transaction of the derivative works that is secondarily created.

An example is now taken to briefly illustrate the conception of the method for implementing a derivative NFT. In the example, two source NFTs, e.g., a source NFT #1 representing original works by a creator A and a source NFT #2 representing original works by a creator B, are available on the blockchain and a creator C conducted a secondary creation on the original works by the creators A and B (e.g. by combining the original works by the creator A and the source works by the creator B) to obtain derivative works. In this case, a smart contract C is provided and the owner of each of the two sources NFTs #1 and #2 is changed to the smart contract C. Then, a derivative NFT is minted under the smart contract C to represent the derivative works, and a derivation relationship between the derivative NFT and the two source NFTs is recorded, for example, in the smart contract C, in metadata of the derivative NFT, or any place off blockchain but with an address of the place being available in the smart contract C or the metadata.

In this way, the derivative NFT representing derivative works which is more applicable to a secondary creation scenario is minted in such a way that the derivation of the derivative works from the source works is clearly indicated, and the source NFTs are prevented from being traded once the derivative NFT is minted, thereby enabling the on-chain transaction of the derivative works and lowering the costs for transfer transactions of NFTs on the blockchain. Further, by storing the derivation relationship between the derivative NFT and the one or more source NFTs and the original owner of each of the one or more source NFTs, traceback of the source NFTs is enabled to allow for verification of the source of the derivative NFT, and further the source NFTs can be restored as desired, thus providing significant flexibility.

It should be understood that the above method is also applicable to a cooperative creation scenario, which is different from the above-described secondary creation scenario merely by the absence of a dependency relationship between multiple source works, thus an order in which the multiple source works are created is not defined. Therefore, the description of the application of the above method to the cooperative creation scenario is not repeated herein.

Some illustrative embodiments of the invention will be described in detail below with reference to the accompanying drawings.

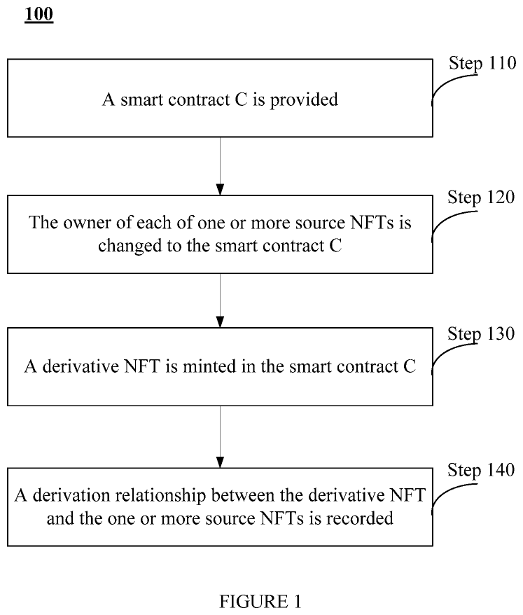

Reference is now made to FIG. 1 illustrating a schematic flowchart of a method for implementing a derivative NFT according to an embodiment of the present invention. It should be noted that the illustrated method may further include additional step(s) not shown in the drawing, and the present disclosure is not limited thereto. As shown in FIG. 1, a method 100 includes below Steps 110 to 140.

At Step 101, a smart contract C is provided.

Particularly, the smart contract C may be newly created. Alternatively, the smart contract C may be an existing smart contract, and the present disclosure is not limited thereto.

As Step 120, the owner of each of one or more source NFTs is changed to the smart contract C.

The source NFTs may be minted under the same smart contract or different smart contracts, and may be owned by the same account or different accounts on blockchain. Given the smart contract C, the owner of the one or more source NFTs is changed to the smart contract C.

The source NFTs may be independent of each other. Alternatively, the source NFTs may be corelated. For example, lyrics, music and musical arrangement form a song together and thus are corelated, therefore, a first source NFT representing the lyrics, a second source NFT representing the music and a third source NFT representing the musical arrangement are corelated.

At Step 130, a derivative NFT is minted in the smart contract C.

Particularly, the derivative NFT minted in the smart contract C represents derivative works derived from works represented by the one or more source NFTs. For example, if the source NFTs are composed of the first source NFT representing the lyrics and the second source NFT representing the music, the minted derivative NFT may represent derivative works which is a combination of the lyrics represented by the first source NFT and the music represented by the second source NFT.

At Step 140, a derivation relationship between the derivative NFT and the one or more source NFTs is recorded.

Particularly, the derivation relationship between the derivative NFT and the one or more source NFTs may be recorded in the smart contract C on blockchain or recorded off blockchain. The derivation relationship includes mapping between an address of an original smart contract in which each of the one or more source NFTs is minted as well as a Token ID of each of the one or more source NFTs and a Token ID of the derivative NFT, so that after the derivative NFT is minted, it is possible to uniquely trace back the derivative NFT to the source NFTs by using the derivation relationship.

Here, the works represented by the source NFTs may be independent of each other, for example, the works represented by one of the source NFTs may be a picture, and the works represented by another one of the source NFTs may be a song without connection with the picture. Alternatively, the works represented by the source NFTs may be corelated, for example, the works represented by one of the source NFTs is lyrics and the works represented by another one of the source NFTs is music accompanying with the lyrics. However, the present disclosure is not limited thereto.

The solution of the above embodiment is particularly applicable to a secondary creation scenario and a cooperative creation scenario, because the derivative NFT representing derivative works which is derived from previous source works (which may be corelated with each other or independent of each other) may be minted in such a manner that the derivation of the derivative works from the source works is clearly indicated, and the previous source works and the secondarily created works can be traded together on the blockchain by using the derivative NFT.

As shown in FIG. 3, a first source NFT with a Token ID 101 and owned by an owner X has been minted in a first source smart contract A to represent lyrics works w101 created by a first creator, a second source NFT with a Token ID 102 and owned by an owner Y has been minted in a second source smart contract B to represent music works w102 composed by a second creator for the lyrics works, and subsequently a third creator conducted a secondary creation on the works w101 and w102 (e.g., by combining the works w101 and w102) to obtain a derivative work w103.

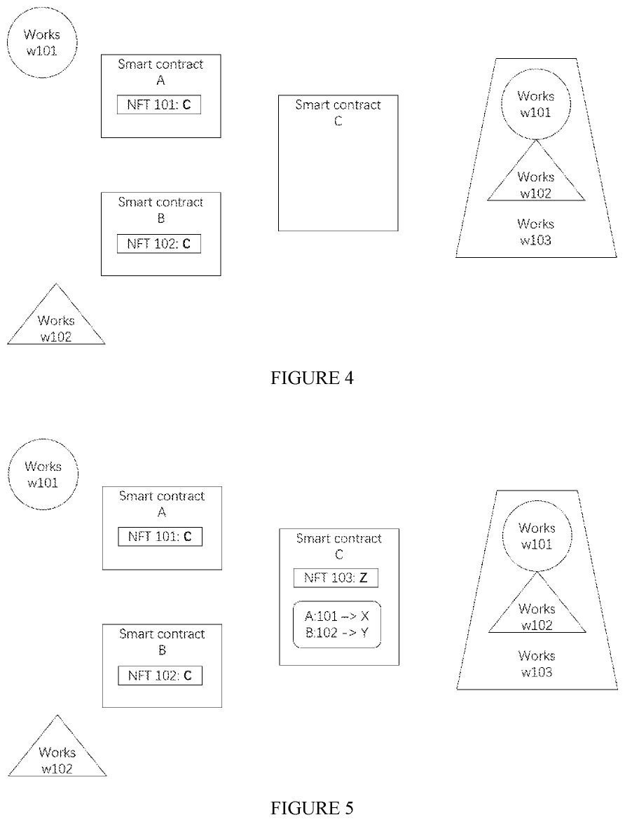

To mint a derivative NFT accompanied by the derivation relationship between the derivative NFT 103 and the source NFTs 101 and 102, the above Step 110 and Step 120 in the embodiment are performed to provide a smart contract C and change the owners of the source NFTs 101 and 102 to the smart contract C, as shown in FIG. 4. At this point, the first source NFT 101 and the second source NFT 102 are owned by the smart contract C.

Then, as shown in FIG. 5, a derivative NFT with a Token ID 103 and owned by an owner Z is minted in the smart contract C to represent the derivative works w103. Further, FIG. 5 shows the derivation relationship between the derivative NFT 103 and the source NFTs 101 and 102, that is, the derivative NFT 103 is derived from the source NFT 101 in the smart contract A and the source NFT 102 in the smart contract B. It should be noted that the derivation relationship may be stored in the smart contract C on blockchain or stored off blockchain, as long as it is accessible.

In addition, modification description, which describes a modification made to the works w101 and w102 represented by the source NFTs 101 and 102 to obtain the derivative works w103, may be generated and included in the metadata of the derivative NFT 103.

In the prior art, after an NFT representing the derivative NFT is traded, it may happen that the source NFTs from which the derivative NFT is derived are also unintentionally traded, thus causing confusion of the ownership of the involved works. In the present disclosure, however, the owner(s) of the source NFTs is changed to the provided smart contract C and thus is prevented from being tampered by any account other than the smart contract C, thereby ensuring that the source NFTs cannot be traded but the derivative NFT can.

The preventing the owner of the one or more source NFTs from being tampered refers to that the source NFTs owned by the smart contract C cannot be manipulated by any account or other smart contract other than the smart contract C, and the manipulation includes, but is not limited to, modifying the source NFTs, changing the owner of the source NFTs, authorizing the source NFTs to a third party, and so on.

In an embodiment, the smart contract C may be configured to change the owner of the derivative NFT to a target account on blockchain, if desired. As understood, once the derivative NFT is minted, the derivative NFT can be traded independently on the blockchain in place of the source NFTs, and subsequently the another account, which has obtained the owner of the derivative NFT, can further trade the derivative NFT on the blockchain.

In an embodiment, the derivation relationship between the derivative NFT and the one or more source NFTs, as well as the original owner of each of the one or more source NFTs, is recorded in the smart contract C on blockchain. As such, if desired, the current owner of the derivative NFT is able to restore the one or more source NFTs from the derivative NFT by using the derivation relationship recorded in the smart contract C, so that the works represented by the source NFTs can again be subjected to secondary creation or the source NFTs can be utilized individually.

As shown in FIG. 5, for example, the derivation relationship between the derivative NFT and the source NFTs, as well as the original owner of each of the source NFTs, is stored in the smart contract C. In this case, if the owner of the derivative NFT has been changed to an account other than the smart contract C, in order for restoring the source NFTs, the owner of the derivative NFT is changed back to the smart contract C or the derivative NFT is authorized by the account to the smart contract C.

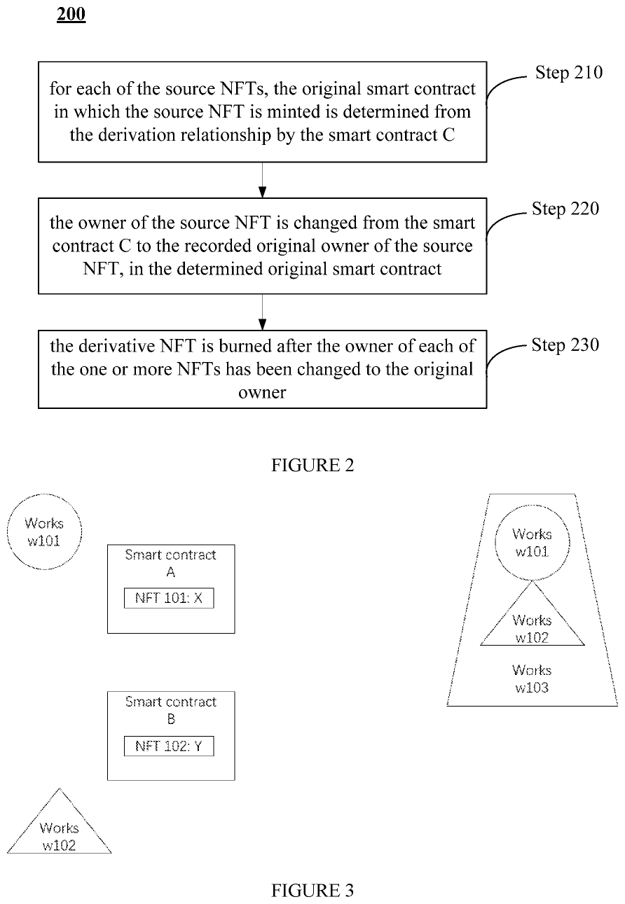

Reference is now made to FIG. 2 which shows a method of restoring one or more source NFTs from a derivative NFT. To restore the source NFTs, below Steps 210 to 230 are performed.

At Step 210, for each of the source NFTs, the original smart contract in which the source NFT is minted is determined from the derivation relationship by the smart contract C.

At Step 220, the owner of the source NFT is changed from the smart contract C to the recorded original owner of the source NFT, in the determined original smart contract.

At Step 230, the derivative NFT is burned after the owner of each of the one or more NFTs has been changed to the original owner.

In an example, a derivative NFT is currently owned by an account X. In order to restore one or more source NFTs from which the derivative NFT is derived, the owner of the derivative NFT needs to be changed from the account X to the smart contract C under which the derivative NFT was minted, or the derivative NFT needs to be authorized by the account X to the smart contract C, so that the smart contract C is entitled to manipulate the derivative NFT. Meanwhile, a first restoring instruction, which instructs to restore the one or more source NFTs by the smart contract C and to change the owner of the restored NFTs from the smart contract C back to the account X, may be sent from the account X to the smart contract C. Subsequently, the one or more source NFTs corresponding to the derivative NFT are determined from the recorded derivation relationship by the smart contract C, and the owner of the source NFTs is changed to the account X. Eventually, the derivative NFT may be burned by the smart contract C after the source NFTs are transferred. As such, the source NFTs are owned by the account X.

Optionally, a second restoring instruction, which instructs to change the owner of each of the one or more source NFTs restored from the derivative NFT by the smart contract C to another designated account, may be sent to the smart contract C from the account X, so that both of restoring and trading of the source NFT are accomplished.

In the embodiments, a solution of restoring the one or more source NFTs from the derivative NFT is provided to allow the works represented by the source NFTs to be subjected to secondary creation again or to allow the source NFTs to be utilized individually, thereby providing better user experience in NFT creation.

In an alternative embodiment, if restoring the source NFTs from the derivative NFT is not required, the derivation relationship may be stored in an application or database off the blockchain, with an access address of the derivation relationship being available in the smart contract C or the metadata, to avoid the high costs for on-chain storage of the derivation relationship.

For example, the derivation relationship may be stored in an application off the blockchain. As for any account which has obtained the derivative NFT, it is possible to determine the one or more source NFTs corresponding to the derivative NFT according to the derivation relationship stored in the application, and further verify the derivative NFT.

In an embodiment, to further improve the capability of tracing back the source from the derivative NFT, an original smart contract and/or an original owner of the one or more source NFTs may be recorded on or off the blockchain. In this way, if the current owner of the derivative NFT desires to verify the source of the derivative NFT, it is possible to trace back to the original smart contract and the original owner of the corresponding source NFTs. Further, when the one or more NFTs are restored from the derivative NFT, each of the source NFTs may be restored to its original owner.

In an embodiment, the derivative NFT may be utilized as a source NFT to recursively implement a next-generation derivative NFT. For example, in the case of the song, after the derivative NFT representing derivative works which is a combination of the lyrics and the music is minted by Steps 110 to 130, if a further creator F creates musical arrangement based on the music and mints an NFT to represent the created musical arrangement, then it is possible to perform the above-described method for implementing a derivative NFT by using the derivative NFT representing the derivative works which is a combination of the lyrics and the music and the minted NFT representing the musical arrangement as source NFTs, to mint a next-generation derivative NFT to represent derivative works which is a combination of the lyrics, the music and the musical arrangement.

In the flows of the methods provided in the embodiments, some operations are described as various steps performed in a certain order. These flows are illustrative but not limitative. For example, some of the steps may be grouped together and performed within a single operation, or may be divided into a plurality of sub-steps, or may be performed in an order different from that as described herein. The various steps in the flows may be performed by a circuitry and/or other tangible mechanisms (for example, software running on a computing device, hardware such as a processor or a logic function implemented by a chip, and/or any combination thereof.

Like the conception of the above-described method for implementing a derivative NFT, an embodiment of the present invention provides a corresponding apparatus for implementing a derivative NFT. Because the principle of the apparatus for addressing the problems according to the embodiment is similar to that of the method, reference may be made to the description of the method and duplicated description will not be repeated hereinafter.

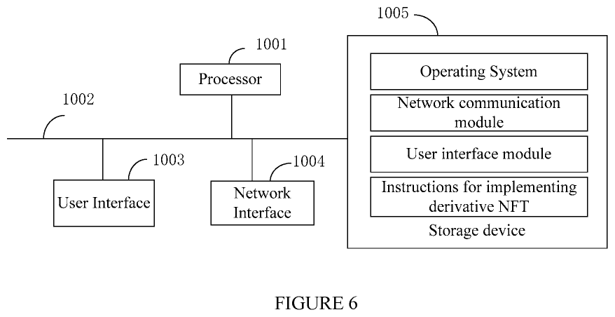

As shown in FIG. 6 which is a schematic diagram showing the structure of an apparatus for implementing a derivative NFT according to an embodiment of the present invention, the apparatus includes a processor 1001 such as a CPU, a network interface 1004, a user interface 1003, a storage device 1005 and a communication bus 1002 configured for communication among the above components. The user interface 1003 may include a display, an input unit such as a keyboard, and optionally a standard wired interface and a wireless interface. The network interface 1004 may optionally include a standard wired interface and a wireless interface such as a Wi-Fi interface. The storage device 1005 may be a high-speed RAM or a non-volatile memory such as a disk storage. Alternatively, the storage device 1005 may be a storage means independent of the processor 1001.

As understood by those skilled in the art, the structure of the apparatus for implementing a derivative NFT as shown in FIG. 6 is merely illustrative instead of limitative, and more or less parts or a different arrangement of parts may be included.

As shown in FIG. 6, as a computer storage medium, the storage device 1005 may be stored with an Operating System, a network communication module, a user interface module and instructions for implementing a derivative NFT. The Operating System is configured to manage and control hardware and software resources of the apparatus for implementing the derivative NFT and support the execution of the program for implementing the derivative NFT and other software or programs.

In the apparatus for implementing the derivative NFT as shown in FIG. 6, the processor 1001 is configured to invoke the program for implementing the derivative NFT that is stored in the storage device 1005 and perform steps of.
providing a smart contract and changing an owner of each of one or more source NFTs to the smart contract,
minting a derivative NFT in the smart contract, with the derivative NFT representing derivative works derived from works represented by the one or more source NFTs, and
recording a derivation relationship between the derivative NFT and the one or more source NFTs.

With the above solutions, a derivative NFT representing derivative works which is more applicable to a secondary creation scenario or a cooperative creation scenario can be minted in such a way that the derivation of the derivative works from the source works is clearly indicated, and the source NFTs are owned by the provided smart contract and prevented from being traded once the derivative NFT is minted, thereby enabling the on-chain transaction of the derivative works and lowering the costs for transfer transactions of NFTs on the blockchain.

Further, by storing the derivation relationship between the derivative NFT and the one or more source NFTs and the original owner of each of the one or more source NFTs, traceback of the source NFTs is enabled to allow for verification of the source of the derivative NFT, and further the source NFTs can be restored as desired, thus providing significant flexibility.

It should be noted that the apparatus in the embodiment can perform the various steps of the above-described methods according to the embodiments, to achieve similar effects and functions as the method, which will not be repeated hereinafter.

According to an embodiment of the invention, provided is a non-volatile computer-readable storage medium stored with computer-executable instructions which, when executed by a processor, causes the processor to perform the method for implementing a derivative NFT in the above embodiments.

The above computer program product may be embodied by hardware, software or a combination thereof. In an embodiment, the computer program product is embodied by a computer storage medium, while in another embodiment, the computer program product is embodied by a software product such as a Software Development Kit (SDK).

The above various embodiments of the invention are described in a progressive manner, the description of the successive embodiment emphasizes on parts different from the previous embodiments, and the description of relevant parts may be referred to among the embodiments. Since the embodiments of the apparatus and the computer-readable storage medium are like those of the corresponding method, the description thereof is simplified, and reference may be made to the relevant parts of the embodiments of the method. However, the apparatuses and the computer-readable storage medium are likewise advantageous as the corresponding method.

The present disclosure has been described with reference to the flowcharts and/or block diagrams of the method, the apparatus and the computer-readable storage medium according to the embodiments of the invention, and it should be understood that each flow and/or block of the flowchart and/or block diagram may be implemented by computer program instructions. These instructions may be provided to a processor of a general computer, a dedicated computer, an embodied system or other programmable data processing device, so that the executing of the instructions by the processor results in a device for implementing a function specified by one or more steps in the flowchart and/or one or more blocks in the block diagram.

Alternatively, these instructions may be loaded to a computer or other programmable data processing devices to cause the computer or other programmable data processing devices to execute a sequence of operation steps, that is, the execution of the instructions on the computer or other programmable data processing devices results in steps for implementing the function of one or more steps in the flowchart and/or one or more blocks in the block diagram.

The computer-readable storage medium may be transient or non-transient, and may be mobile or immobile. Examples of the computer-readable storage medium include, but are not limited to, a Phase Change Random Access Memory (PRAM), a Static Random Access Memory (SRAM), a Dynamic Random Access Memory (DRAM), any other types of Random Access Memories (RAMs), a Read Only Memory (ROM), an Electrically Erasable Programmable Read-Only Memory (EEPROM), a Flash, a Compact Disc Read-Only Memory (CD-ROM), a Digital Video Disk (DVD) or other optical storages, which are adapted to store information accessible by a computing device.

Although the conception and principles of the present disclosure have been described with reference to several embodiments, it shall be understood that the present disclosure is not limited to the embodiments as disclosed, nor does the division of the aspects imply that the features in those aspects cannot be combined for benefit, such division being for convenience of presentation only. The present disclosure is intended to cover various modifications and equivalent arrangements included within the scope of the appended claims.

What is claimed is:

1. A method for implementing a derivative Non-Fungible Token (NFT), comprising:
providing a smart contract and changing an owner of each of one or more source NFTs to the provided smart contract,
minting a derivative NFT in the provided smart contract, with the derivative NFT representing derivative works derived from works represented by the one or more source NFTs, and
recording a derivation relationship between the derivative NFT and the one or more source NFTs.

2. The method of claim 1, further comprising:
generating modification description, which describes a modification made to the works represented by the one or more source NFTs to obtain the derivative works, and which is included in metadata of the derivative NFT.

3. The method of claim 1, wherein the derivation relationship between the derivative NFT and the one or more source NFTs is recorded in the smart contract on blockchain or recorded off blockchain.

4. The method of claim 1, wherein the derivation relationship comprises mapping between an address of an original smart contract in which each of the one or more source NFTs is minted as well as a Token ID of each of the one or more source NFTs and a Token ID of the derivative NFT.

5. The method of claim 4, further comprising: recording an original owner of each of the one or more source NFTs in the provided smart contract.

6. The method of claim 5, further comprising restoring each of the one or more source NFTs by steps of:
determining the original smart contract in which the source NFT is minted, based on the derivation relationship by the provided smart contract,
changing the owner of the source NFT from the provided smart contract to the recorded original owner of the source NFT, in the determined original smart contract, and
burning the derivative NFT after the owner of each of the one or more NFTs has been changed to the original owner.

7. The method of claim 1, further comprising changing an owner of the derivative NFT from the provided smart contract to a target account on blockchain.

8. The method of claim 7, before restoring each of the one or more source NFTs, further comprising changing the owner of the derivative NFT owned by the target account to the provided smart contract or authorizing the derivative NFT by the target account to the provided smart contract.

9. The method of claim 1, further comprising:
utilizing the derivative NFT as a source NFT to recursively implement a next-generation derivative NFT.

10. An apparatus for implementing derivative NFT comprising:
at least one processor, and
a storage device in communication with the at least one processor,
wherein the storage device is stored with instructions which, when executed by the at least one processor, cause the at least one processor to perform the method of claim 1.

11. A computer-readable storage medium stored with a program which, when executed by a processor, causes the processor to perform the method of claim 1.
